(19) United States
(12) Patent Application Publication
(10) Pub. No.: US 2017/0118977 A1
(43) Pub. Date: May 4, 2017

(54) MITE REPELLENT, AND MITE-REPELLENT RESIN COMPOSITION AND MITE-REPELLENT PRODUCT USING SAME

(71) Applicant: TOAGOSEI CO., LTD., Tokyo (JP)

(72) Inventor: Satoko ANDO, Nagoya-shi (JP)

(73) Assignee: TOAGOSEI CO., LTD., Tokyo (JP)

(21) Appl. No.: 15/318,008

(22) PCT Filed: Jun. 16, 2015
(86) PCT No.: PCT/JP2015/067289

§ 371 Date: Dec. 12, 2016

(30) Foreign Application Priority Data
Jun. 19, 2014 (JP) 2014-125852

(51) Int. Cl. A01M 29/12; A01N 37/04; A01N 25/08

(52) U.S. Cl. CPC A01M 29/12; A01N 25/08; A01N 37/04

(57) ABSTRACT

There is provided a mite repellent having a high mite repellent effect and excellent formability. Further, there is provided a mite repellent product obtained by using the mite repellent and various resins in which the product is a fiber, sheet, or molded product exhibiting excellent mite repellency. The mite repellent of the present invention comprises a chemical supported on an inorganic porous substance, in which the chemical is aliphatic dibasic acid dialkyl ester having a specific structure, the inorganic porous substance has a BET specific surface area of from 550 to 1000 m²/g and a pore size of from 0.8 to 15 nm, and a supported amount of the chemical is from 0.007 to 0.09 ml with respect to 100 m² of the BET specific surface area of the inorganic porous substance.

### TECHNICAL FIELD

The present invention relates to a mite repellent. Further, the present invention relates to a mite-repellent resin composition and a mite repellent product using the mite repellent.

### BACKGROUND ART

There are various chemicals having a repellent effect on mites as insect pests. As a chemical having excellent repellency and high stability, an aliphatic dibasic acid dialkyl ester compound is known (for example, Patent Documents 1 and 2). However, in a case in which the chemical is applied to a processed product such as a fiber product or a resin-molded article, the chemical is thermally decomposed or vaporized by heat during processing. Thus, the repellent effect is reduced, which is problematic. Further, smoke is easily generated by the vaporization of the chemical. In many cases, this is problematic in the work environment.

In view of such a problem, Patent Document 3 discloses a mite-controlling resin composition obtained by allowing a mite-controlling agent composed of natural soil for dyeing or zeolite, a specific aliphatic system, aromatic polybasic acid dialkyl ester or the like to be supported on a carrier and kneading the resultant product into a thermoplastic resin.

### PRIOR ART

### Patent Document

Patent Document 1: Japanese Patent Application Laid-Open (JP-A) No. H9-3241

Patent Document 2: JP-A No. H10-110061

Patent Document 3: JP-A No. 2004-123593

### SUMMARY OF THE INVENTION

### Means for Solving the Problems

However, the aliphatic dibasic acid dialkyl ester compound disclosed in Patent Documents 1 and 2 is singly kneaded into a resin, as a result of which the chemical is thermally decomposed or vaporized by high temperatures, whereby the repellent effect decreases. Further, the chemical is vaporized during melting and kneading, which causes smoke. This is problematic in the work environment.

The mite repellent effect in early stage of the natural soil for dyeing or zeolite disclosed in Patent Document 3 is low and it does not reach a practical level. Further, there is a problem in that a mite repellent having a specific compound supported thereon shows an insufficient repellent rate after heat treatment.

The present invention has been achieved in view of the above circumstances. An object to be solved by the present invention is to provide a mite repellent having a high mite repellent effect and excellent formability. Further, the object is to provide a mite repellent product obtained by using the mite repellent and various resins in which the product is a fiber, sheet, or molded product exhibiting excellent mite repellency.

### Means for Solving the Problems

The present inventors have found that a mite repellent is prepared by allowing specific aliphatic dibasic acid dialkyl ester to be supported on an inorganic porous substance having a BET specific surface area and a pore size within a specific range and the resultant mite repellent has a high mite repellent effect and excellent heat resistance, and they have completed the present invention.

That is, the present invention is as follows:

<1> a mite repellent comprising a chemical supported on an inorganic porous substance, wherein the chemical is aliphatic dibasic acid dialkyl ester represented by the following Formula (1), the inorganic porous substance has a BET specific surface area of from 550 to 1000 m²/g and a pore size of from 0.8 to 15 nm, and a supported amount of the chemical is from 0.007 to 0.09 ml with respect to 100 m² of the BET specific surface area of the inorganic porous substance,

ROOC(CH₂)ₙCOOR (1)

wherein, in formula (1), n represents an integer from 3 to 15, R represents an alkyl group having from 3 to 15 carbon atoms when n represents an integer from 3 to 8, and R represents an alkyl group having from 1 to 15 carbon atoms when n represents an integer from 9 to 15;

<2> the mite repellent according to <1>, wherein the chemical has a boiling point of 300° C. or higher;

<3> the mite repellent according to <1> or <2>, wherein the inorganic porous substance is at least one selected from the group consisting of a silicate compound, silica gel, zeolite, metal oxide, metal hydroxide, or a phosphate compound;

<4> the mite repellent according to any one of <1> to <3>, wherein a water content in the inorganic porous substance before supporting the chemical is 3% by mass or less;

<5> a mite-repellent resin composition including the mite repellent according to any one of <1> to <4>; and <6> a mite repellent product including the mite repellent according to any one of <1> to <4>.

According to the present invention, there can be provided a mite repellent having a high mite repellent effect and excellent formability. Further, there can be provided a mite repellent product obtained by using the mite repellent and various resins in which the product is a fiber, sheet, or molded product exhibiting excellent mite repellency.

### MODES FOR CARRYING OUT THE INVENTION

One embodiment of the present invention will be described as follows, but the present invention is not limited thereto. Unless otherwise specified, percentages and parts are by mass.

(1) Mite Repellent

The mite repellent of the present invention is a mite repellent comprising a chemical supported on an inorganic porous substance, wherein the chemical is aliphatic dibasic acid dialkyl ester represented by the following Formula (1), the inorganic porous substance has a BET specific surface area of from 550 to 1000 m²/g and a pore size of from 0.8 to 15 nm, and a supported amount of the chemical is from 0.007 to 0.09 ml with respect to 100 m² of the BET specific surface area of the inorganic porous substance. The structural components of the present invention will be specifically described.

The present inventors have conducted intensive examinations. As a result, they have found that the mite repellent of the present invention has a high mite repellent effect and excellent formability, and a product obtained by using the mite repellent and various resins exhibits excellent mite repellency.

The term “formability” means that in a case in which a heat treatment or the like is performed in order to process a composition containing the mite repellent of the present invention, the level of odor is low and little foam is generated from the product.

Further, the term “excellent mite repellency of the product” means that the product exhibits excellent mite repellency immediately after processing and has an appropriate sustained release property. The term “sustained release property” means that the chemical is gradually released from the inorganic porous substance and the mite repellent effect continues.

The detailed mechanism is not clear. It is assumed that the mite repellent of the present invention has a high mite repellent effect since a configuration in which a predetermined amount of specific aliphatic dibasic acid dialkyl ester (chemical) is supported on an inorganic porous substance having a BET specific surface area and a pore size within a specific range is employed, whereby the chemical is uniformly spread and supported on inorganic porous pores and the ratio of the chemical effectively acting on mites is increased.

Further, it is assumed that since the above configuration suppresses the flowing away of the chemical due to the heat treatment or the like during processing, the mite repellent of the present invention has high heat resistance.

Furthermore, it is assumed that the amount of the chemical remained in the product is increased after the processing by heat treatment or the like because of the high heat resistance, and thus the product exhibits excellent mite repellency. In addition, it is assumed that the product has excellent formability since the occurrence of odor and foaming by the thermal decomposition and vaporization of the chemical is suppressed because of the high heat resistance.

Further, the present inventors have conducted intensive examinations. As a result, they have found that a product obtained by using the mite repellent of the present invention and various resins has excellent water resistance.

The term “excellent water resistance” means that the product exhibits excellent mite repellency even after being in contact with water.

The detailed mechanism to obtain water resistance is not clear. It is assumed that even when the mite repellent according to the present invention is in contact with water, the discharge of the mite repellent is suppressed, because a predetermined amount of a specific chemical is supported on an inorganic porous substance having a BET specific surface area and a pore size within a specific range.

The chemical to be used in the present invention is aliphatic dibasic acid dialkyl ester represented by the following Formula (1):

ROOC(CH₂)ₙCOOR (1)

In the above Formula (1), n represents preferably an integer from 3 to 15, preferably an integer from 3 to 12, and more preferably an integer from 4 to 10. When n represents an integer from 3 to 15, the chemical easily enters into pores of the inorganic porous substance and thus an appropriate sustained release property can be obtained.

Further, R represents an alkyl group having from 3 to 15 carbon atoms when n represents an integer from 3 to 8, and R represents an alkyl group having from 1 to 15 carbon atoms when n represents an integer from 9 to 15.

When n represents an integer from 3 to 8, R represents an alkyl group having from 3 to 15 carbon atoms. Specific examples thereof include a propyl group, a butyl group, a pentyl group, a hexyl group, a heptyl group, an octyl group, a 2-ethylhexyl group, a nonyl group, a decyl group, and a dodecyl group. The alkyl group may be branched. Among them, a butyl group, a pentyl group, a hexyl group, a heptyl group, an octyl group, and a 2-ethylhexyl group are preferred in terms that it is easy to enter into pores of the inorganic porous substance and it is possible to obtain an appropriate sustained release property.

When n represents an integer from 9 to 15, R represents an alkyl group having from 1 to 15 carbon atoms. Specific examples thereof include a methyl group, an ethyl group, a propyl group, a butyl group, a pentyl group, a hexyl group, a heptyl group, an octyl group, a 2-ethylhexyl group, a nonyl group, a decyl group, and a dodecyl group. The alkyl group may be branched. Among them, a butyl group, a pentyl group, a hexyl group, a heptyl group, an octyl group, and a 2-ethylhexyl group are preferred in terms that it is easy to enter into pores of the inorganic porous substance and it is possible to obtain an appropriate sustained release property.

Examples of the aliphatic dibasic acid dialkyl ester represented by Formula (1) include dipropyl glutarate, dibutyl glutarate, diisobutyl glutarate, dipentyl glutarate, dihexyl glutarate, diheptyl glutarate, dioctyl glutarate, bis(2-ethylhexyl)glutarate, dinonyl glutarate, didecyl glutarate, didodecyl glutarate, dipropyl adipate, dibutyl adipate, diisobutyl adipate, dipentyl adipate, dihexyl adipate, diheptyl adipate, dioctyl adipate, bis(2-ethylhexyl)adipate, dinonyl adipate, didecyl adipate, didodecyl adipate, dipropyl pimelate, dibutyl pimelate, diisobutyl pimelate, dipentyl pimelate, dihexyl pimelate, diheptyl pimelate, dioctyl pimelate, bis(2-ethylhexyl)pimelate, dinonyl pimelate, didecyl pimelate, didodecyl pimelate, dipropyl suberate, dibutyl suberate, diisobutyl suberate, dipentyl suberate, dihexyl suberate, diheptyl suberate, dioctyl suberate, bis(2-ethylhexyl)suberate, dinonyl suberate, didecyl suberate didodecyl suberate, dipropyl azelate, dibutyl azelate, diisobutyl azelate, dipentyl azelate, dihexyl azelate diheptyl azelate, dioctyl azelate, bis(2-ethylhexyl)azelate, dinonyl azelate, didecyl azelate, didodecyl azelate, dipropyl sebacate dibutyl sebacate, diisobutyl sebacate, dipentyl sebacate, dihexyl sebacate, diheptyl sebacate, dioctyl sebacate, bis(2-ethylhexyl)sebacate, dinonyl sebacate, didecyl sebacate, didodecyl sebacate, dipropyl dodecanedioate, dibutyl dodecanedioate, diisobutyl dodecanedioate, dipentyl dodecanedioate, dihexyl dodecanedioate, diheptyl dodecanedioate, dioctyl dodecanedioate, bis(2-ethylhexyl)dodecanedioate, dinonyl dodecanedioate, didecyl dodecanedioate, and didodecyl dodecanedioate. These aliphatic dibasic acid dialkyl ester compounds may be used singly, or in combination/mixture of two or more kinds thereof.

The boiling point of the chemical is preferably 300° C. or higher, more preferably 310° C. or higher, and yet more preferably 320° C. or higher. In a case in which the boiling point of the chemical is 300° C. or higher, when a mite repellent and a thermoplastic resin are melted and kneaded, neither foaming nor strong odor are generated from the chemical and the mite repellent has excellent heat resistance.

The upper limit of the boiling point of the chemical is not particularly limited, and no problem in use of the chemical is caused when the boiling point is 500° C. or lower.

Further, the melting point of the chemical is preferably 10° C. or lower. When the melting point is 10° C. or lower, the chemical is easily supported on an inorganic porous substance because the chemical is liquid at an ordinary temperature (from 10 to 30° C.), and further the resultant mite repellent has an appropriate sustained release property.

The lower limit of the melting point of the chemical is not particularly limited, and no problem in use of the chemical is caused when the melting point is −80° C. or higher.

The inorganic porous substance to be used in the present invention is an inorganic porous substance having a BET specific surface area of from 550 to 1000 m²/g and a pore size of from 0.8 to 15 nm. The BET specific surface area of the inorganic porous substance is preferably from 600 to 900 m²/g, and more preferably from 650 to 800 m²/g. When the BET specific surface area is less than 550 m²/g, the mite repellent effect tends to decrease. Meanwhile, when the BET specific surface area exceeds 1000 m²/g, the chemical is easily bled from the inorganic porous substance because the oil absorption decreases. As a result, an appropriate sustained release property may not be obtained. In this regard, the BET specific surface area in the present invention is a value measured by AUTOSORB-1, manufactured by Quantachrome Instruments.

The pore size of the inorganic porous substance is preferably from 1.0 to 10 nm, and more preferably from 1.5 to 7 nm. When the pore size is less than 0.8 nm, the chemical cannot sufficiently enter into pores of the inorganic porous substance. Meanwhile, when the pore size exceeds 15 nm, the chemical hardly remains in pores of the inorganic porous substance and an appropriate sustained release property may not be obtained. The pore size measurement method of the present invention will be described below.

Examples of the inorganic porous substance having the BET specific surface area and the pore size include a silicate compound, silica gel, zeolite, metal oxide, metal hydroxide, and a phosphate compound. Among them, a silicate compound, silica gel, or zeolite is preferred, and silica gel is particularly preferred, in terms of having a large BET specific surface area and the above-described pore size.

Examples of the silicate compound include aluminum silicate and magnesium silicate. The aluminum silicate and magnesium silicate may be natural or synthetic. Synthetic aluminum silicate is represented by the following Formula (2):

Al₂O₃.nSiO₂.mH₂O (2)

In Formula (2), n represents a positive number from 6 or more. More preferably, n represents a positive number from 6 to 50 and m represents a positive number from 1 to 20. Particularly preferably, n represents a positive number from 8 to 15 and m represents a positive number from 3 to 15. Magnesium silicate is represented by the following Formula (3):

MgO.nSiO₂.mH₂O (3)

In Formula (3), n represents a positive number of 1 or more. More preferably, n represents a positive number from 1 to 20 and m represents a positive number from 0.1 to 20. Yet more preferably, n represents a positive number from 1 to 15 and m represents a positive number from 0.3 to 10. Particularly preferably, n represents a positive number from 3 to 15 and m represents a positive number from 1 to 8.

A synthetic product of silicate compound can be obtained, for example, by the following procedure.

It can be synthesized by mixing an aqueous solution of aluminum salt or magnesium salt with an aqueous solution of alkali metal silicate, adding acid or alkali, if necessary at room temperature and an atmospheric pressure, maintaining a pH of from about 3 to 7 and allowing the resultant mixture to be coprecipitated, aging this coprecipitate at a temperature of from about 40° C. to 100° C., or water-washing, dehydrating, and drying the coprecipitate without aging.

Silica gel showing various characteristics depending on the production method is commercially available. Any silica gel may be used as long as it has the above-described BET specific surface area and pore size.

Further, zeolite may be natural or synthetic. Zeolite has various structures and any known zeolites may be used. Examples of the structures include A-type, X-type, Y-type, α-type, (3-type, and ZSM-5 type structures.

Examples of the metal oxide include aluminium oxide, magnesium oxide, titanium oxide, and zirconium oxide.

Examples of the metal hydroxide include aluminium hydroxide, magnesium hydroxide, titanium hydroxide, and zirconium hydroxide.

Examples of the phosphate compound include aluminium phosphate, zirconium phosphate, titanium phosphate, and tin phosphorate.

The inorganic porous substance contains attached water. In a case in which the water content is high, a chemical is hardly supported on the inorganic porous substance. The water content in the inorganic porous substance before the chemical is supported is preferably from 0 to 3% by mass, and more preferably from 0 to 2.5% by mass. The water content in the inorganic porous substance can be removed by drying under reduced pressure or the like. The water content in the inorganic porous substance is a value measured by the method in accordance with JIS K 0067 (revised 1992) (Test methods for loss and residue of chemical products) 4.1.1 (1).

The mite repellent of the present invention can be produced by the following methods:

(1) a method including: stirring an inorganic porous substance at a temperature of from room temperature to lower than 60° C.; and adding a chemical to this mixture and mixing them;

(2) a method including: stirring an inorganic porous substance at a temperature of from room temperature to lower than 60° C.; adding a solution of a chemical and mixing them; and then removing the solvent;

(3) a method including: stirring a dispersion solution of an inorganic porous substance at a temperature of from room temperature to lower than 60° C.; adding a solution of a chemical and mixing them; and then removing the solvent; and

(4) a method including: stirring a dispersion solution of an inorganic porous substance at a temperature of from room temperature to 60° C.; adding a solution of a chemical and mixing them; and then removing the solvent.

The solvent to be used for preparing the dispersion solution of the inorganic porous substance and the solution of the chemical may be a solvent which can be easily removed after the chemical is supported on the inorganic porous substance. Alcohol having 3 or less carbon atoms, acetone, water or the like is preferred. In the production method, the order of adding the inorganic porous substance and the chemical may be reversed. In other words, the method may be a method including: stirring a chemical or its solution at a temperature of from room temperature to 60° C.; and adding an inorganic porous substance or its dispersion solution to the resultant mixture.

The mixture obtained by the production method may be further dried. As a result of being dried, defects such as foaming and discoloration are hardly caused when adding to a resin or a fiber. The drying temperature is preferably from 60 to 120° C., and more preferably from 80 to 110° C. The drying may be performed under reduced pressure. The drying time may be appropriately set since there is an optimal time depending on the drying temperature, the amount of throughput, and the device.

In the case of producing the mite repellent, it is necessary that the supported amount of the chemical is from 0.007 to 0.09 ml with respect to 100 m² of the BET specific surface area of the inorganic porous substance. The supported amount of the chemical is preferably from 0.008 to 0.08 ml, more preferably from 0.01 to 0.08 ml, and yet more preferably from 0.02 to 0.07 ml. When the supported amount of the chemical is less than 0.007 ml, a mite repellent effect may not be sufficiently obtained. Meanwhile, when the supported amount of the chemical exceeds 0.09 ml, strong odor is caused by the thermal decomposition and vaporization of the chemical during molding a resin composition containing the mite repellent. This is problematic in the work environment. Further, the mite repellent effect tends to decrease.

(2) Mite-Repellent Resin Composition

A mite-repellent resin composition can be easily obtained by blending the mite repellent of the present invention with a resin. The kind of resin to be used is not particularly limited. The resin may be any of a natural resin, a synthetic resin, and a semi-synthetic resin, or may be either a thermoplastic resin or a thermosetting resin. Specifically, the resin may be any one of a molding resin, a fiber resin, and a rubbery resin. Examples of the resin include molding or fiber resins such as polyethylene, polypropylene, vinyl chloride, ABS resin, AS resin, MBS resin, nylon resin, polyester, polyvinylidene chloride, polystyrene, polyacetal, polycarbonate, PBT, acrylic resin, fluorine resin, polyurethane elastomer, polyester elastomer, melamine, urea resin, tetrafluoroethylene resin, unsaturated polyester resin, rayon, acetate, polyvinyl alcohol, cuprammonium rayon, triacetate, and vinylidene; and rubbery resins such as natural rubber, silicone rubber, styrene butadiene rubber, ethylene propylene rubber, fluororubber, nitrile rubber, chlorosulfonated polyethylene rubber, butadiene rubber, synthetic natural rubber, isobutylene-isoprene rubber, polyurethane rubber, and acrylic rubber. Further, a mite-repellent fiber can be produced by allowing the mite repellent of the present invention to be combined with a natural fiber.

As a processing method of blending the mite repellent of the present invention with a resin to form a mite-repellent resin composition, any well-known methods may be employed. For example, there are following methods:

(1) a method of directly mixing a pellet resin or powdered resin using an adherent agent for making a mite-repellent powder easily supported on the resin or a dispersant for improving the dispersibility of the mite-repellent powder;

(2) a method including: molding the mixture obtained in the above manner into a pellet form with an extruder; and blending the molded product with a pellet resin;

(3) a method including: molding a mite repellent into a highly concentrated pellet form using a wax; and then blending the molded product in the form of pellet with a pellet resin; and

(4) a method including: dispersing a mite repellent in a high-viscosity liquid substance (such as polyol) to prepare a paste composition; and then blending this paste with a pellet resin.

When the content of the mite repellent in the mite-repellent resin composition is high, the durability of mite repellency tends to improve. However, when the content is too high, the kinetic property of a mite repellent product is reduced. Accordingly, the content is preferably from 0.1 to 50 parts by mass, and more preferably from 0.3 to 20 parts by weight with respect to 100 parts by mass of the mite-repellent resin composition.

(3) Mite Repellent Product

In order to mold the mite-repellent resin composition, all well-known processing technologies and machines can be used according to the characteristics of various resins. It is possible to obtain a variety of processed products. Specific operations may be carried out in the usual manner. The mite-repellent resin composition can be molded and processed into various forms such as a lump, sponge, film, sheet, filament or pipe form, or any combination thereof.

Examples of the mite repellent product of the present invention include a fiber, a coating material, a sheet, and a resin-molded product.

A mite-repellent fiber containing the mite repellent of the present invention can be used in various fields which need the mite repellency. For example, the fiber can be used in a lot of fiber products including a futon, a quilt cover, a floor cushion, a blanket, a carpet, a curtain, a sofa, a cover, a seat, a car seat, a car mat, and an air filter. The method of adding the mite repellent of the present invention to a fiber product includes a method of attaching the mite repellent to the front or rear surface of a fiber product using a binder resin and a method of allowing the mite repellent to be kneaded into a fiber resin. A mite-repellent coating material containing the mite repellent can be utilized in various fields which need the mite repellency. For example, the coating material can be used in inner and outer walls of buildings, inner walls of rail cars, or the like. A mite-repellent sheet containing the mite repellent of the present invention can be utilized in various fields which need the mite repellency. For example, the sheet can be used in filters such as an air cleaning filter, wallpaper, non-woven fabrics, paper, and films. The mite repellent product containing the mite repellent of the present invention can be utilized in various fields which need the mite repellency. For example, the product can be used in home electronic products such as an air cleaner and a refrigerator, household products such as a trashcan and a drainer, various nursing care products such as portable toilets, or daily use products.

### EXAMPLES

Hereinafter, the present invention will be more specifically described, but is not limited thereto. Hereinafter, parts and percentages are based on mass.

1. Evaluation Method

### (1) BET Specific Surface Area

The BET specific surface area was measured in accordance with JIS Z 8830 (revised in 2013) “Determination of the specific surface area of powders (solids) by gas adsorption” using AUTOSORB-1, manufactured by Quantachrome Instruments.

(2) Pore Size

In the Case of a Pore Size of from 2 to 50 nm (Mesopore)

The pore size was measured in accordance with JIS Z 8831-2 (established in 2010) “Pore size distribution and porosity of powder (solid) materials—Part 2: Analysis of mesopores and macropores by gas adsorption” using AUTOSORB-1, manufactured by Quantachrome Instruments.

In the Case of a Pore Size of Less than 2 nm (Micropore)

The pore size can be measured in accordance with JIS Z 8831-3 (established in 2010) “Pore size distribution and porosity of powder (solid) materials—Part 3: Analysis of micropores by gas adsorption”. As a pore size of less than 2 nm in the present specification, the value of the catalogue of TOSOH CORPORATION was used.

(3) Water Content

The water content was measured by the method in accordance with JIS K 0067 (revised 1992) (Test methods for loss and residue of chemical products) 4.1.1 (1). However, the drying conditions were as follows: temperature=150° C.; and drying time=2 hours.

(4) Formability

A predetermined amount of a mite repellent was added to a polypropylene resin (product name: Prime Polypro J707G, manufactured by Prime Polymer Co., Ltd.), and the resultant mixture was mixed using a Henschel mixer to obtain a mite-repellent resin composition. The supported amount of the chemical in the mite repellent A (Example 1) used in Example 11 was 10%. Thus, when the content of the mite repellent in the resin composition is 4.0%, the content of the chemical (active ingredient) is calculated to be 0.4%.

Subsequently, the mite-repellent resin composition was injection-molded into a flat plate having a length of 110 mm, a width of 110 mm, and a thickness of 2 mm under the conditions described below. Then, the foaming state of this flat plate was evaluated. Further, the resin composition was allowed to accumulate in a molding machine for 5 minutes, and the odor generated during molding was evaluated.

When the foaming state is evaluated to be 2 or 3 and the odor is evaluated to be 2 or 3, it can be said that the mite repellent has excellent formability.

### <Molding Conditions>

Molding machine: model “M-50A(II)-DM”, manufactured by Meiki Co., Ltd. Molding temperature: 250° C.

### <Foam Evaluation Criteria>

3: None foams

2: One to nine foams were observed per flat plate

1: Ten or more foams were observed per flat plate

### <Odor Evaluation Criteria>

The odor strength was graded in six levels shown in Table 1.

3: Odor strength: 1 or less

2: Odor strength: 2

1: Odor strength: 3 or more

TABLE 1

| | | Level of odor |
|---|---|---|
| Odor | 0 | Odorless |
| strength | 1 | Barely detectable odor (detected threshold concentration) |
| | 2 | Weak odor but identifiable of its source (recognized |
| | | threshold concentration) |
| | 3 | Easily detectable odor |
| | 4 | Strong odor |
| | 5 | Intense odor |

(5) Repellency in Early Stage

A disk having a diameter of 40 mm was cut out from the flat plate produced for the evaluation of formability and used as a test piece. The evaluation was carried out by an intrusion-prevention method in accordance with JIS L 1920 “Testing methods for efficacy against house dust mite of textiles”, and the initial repellent rate was calculated. When the initial repellent rate was 80% or more, the mite repellency was determined to be favorable.

(6) Durability of Repellency

The flat plate produced for the evaluation of formability was kept in a dryer at 81° C. for 48 hours. A disk having a diameter of 40 mm was cut out from this flat plate and used as a test piece after heating. The evaluation was performed in the same manner as in the repellency in early stage and the repellent rate (durability of repellency) after heating was calculated. When the repellent rate was 50% or more, the mite repellency was determined to be favorable. When the repellent rate was 80% or more, the mite repellency was determined to be very favorable.

(7) Water Resistance

The flat plate produced for the evaluation of formability was immersed in warm water at 50° C. for 16 hours. A disk having a diameter of 40 mm was cut out from this flat plate and used as a test piece after the water resistance test. The evaluation was performed in the same manner as in the repellency in early stage and the repellent rate (repellent water resistance) was calculated. When the repellent rate was 50% or more, the mite repellency was determined to be favorable. When the repellent rate was 70% or more, the mite repellency was determined to be very favorable.

2. Production of Mite Repellent

### Example 1

Silica gel (product name: “Nipgel CX-200”, manufactured by Tosoh Silica Corporation) was dried at 120° C. under reduced pressure for 24 hours. The water content was 1.5%. While 9.0 g of this silica gel was stirred at room temperature, 1.0 g of dibutyl sebacate was added thereto (the total of the chemical and the inorganic porous substance was 10 g), followed by stirring for 10 minutes to form a mixture. Then, the mixture was dried by heating at 80° C. for 1 hour and a mite repellent A was produced.

### Examples 2 to 9

Pre-drying was performed so that the water content in an inorganic porous substance was from 1.5 to 2.5% by mass. Then, mite repellents B to I were produced in the same manner as in Example 1 except that the chemical, the inorganic porous substance, and the supported amount of the chemical were set as shown in Table 1.

### Comparative Examples 1 to 7

Pre-drying was performed so that the water content in an inorganic porous substance was from 1.5 to 2.5% by mass. Then, mite repellents J to P were produced in the same manner as in Example 1 except that the chemical, the inorganic porous substance, and the supported amount of the chemical were set as shown in Table 1.

In this regard, the abbreviations in Tables 2 and 3 represent the following materials: Chemicals
DBS: dibutyl sebacate (density 0.937 g/cm³, boiling point: 345° C., melting point: −11° C.)
DOA: bis(2-ethylhexyl)adipate (density 0.927 g/cm³, boiling point: 335° C., melting point: −70° C.)
DEA: diethyl adipate (density 1.009 g/cm³, boiling point: 251° C., melting point: −20° C.) Inorganic porous substances
CX-200: product name: “Nipgel CX-200” (silica gel), manufactured by Tosoh Silica Corporation
BY-200: product name: “Nipgel BY-200” (silica gel), manufactured by Tosoh Silica Corporation
NS-100: product name: Kesmon (aluminium silicate), manufactured by Toagosei Co., Ltd.
NS-20: product name: Kesmon (aluminium silicate), manufactured by Toagosei Co., Ltd.
Sylysia 730: product name: “Sylysia 730” (silica gel), manufactured by Fuji Silysia Chemical Ltd.
Sylysia 350: product name: “Sylysia 350” (silica gel), manufactured by Fuji Silysia Chemical Ltd.
Y-type zeolite: product name: “HSZ-385HUA”, manufactured by Tosoh Silica Corporation
β-type zeolite: product name: “HSZ-960HOA”, manufactured by Tosoh Silica Corporation

TABLE 2

| | | | Inorganic porous | | | | |
|---|---|---|---|---|---|---|---|
| | | | substance | | | Supported | |
| | Chemical | | | Specific | | amount of | |
| | | Boiling | | surface | Pore | chemical | |
| | | point | | area | size | mL/100 | % by |
| | Type | (° C.) | Type | (m²/g) | (nm) | m² | mass |
| Example 1 | DBS | 345 | CX-200 | 692 | 4.0 | 0.02 | 10 |
| Example 2 | DBS | 345 | CX-200 | 692 | 4.0 | 0.04 | 20 |
| Example 3 | DBS | 345 | CX-200 | 692 | 4.0 | 0.06 | 30 |
| Example 4 | DOA | 335 | CX-200 | 692 | 4.0 | 0.04 | 20 |
| Example 5 | DBS | 345 | NS-100 | 730 | 2.7 | 0.04 | 20 |
| Example 6 | DBS | 345 | Sylysia | 800 | 2.5 | 0.04 | 20 |
| | | | 730 | | | | |
| Example 7 | DBS | 345 | CX-200 | 692 | 4.0 | 0.01 | 5 |
| Example 8 | DBS | 345 | CX-200 | 692 | 4.0 | 0.08 | 35 |
| Example 9 | DBS | 345 | Y-type | 600 | 0.9 | 0.04 | 20 |
| | | | zeolite | | | | |
| Comparative | DBS | 345 | NS-20 | 530 | 8.0 | 0.04 | 20 |
| example 1 | | | | | | | |
| Comparative | DBS | 345 | Sylysia | 300 | 21.0 | 0.04 | 10 |
| example 2 | | | 350 | | | | |
| Comparative | DBS | 345 | BY-200 | 502 | 10.0 | 0.04 | 15 |
| example 3 | | | | | | | |
| Comparative | DBS | 345 | β-type | 560 | 0.7 | 0.04 | 20 |
| example 4 | | | zeolite | | | | |
| Comparative | DEA | 251 | CX-200 | 692 | 4.0 | 0.04 | 20 |
| example 5 | | | | | | | |
| Comparative | DBS | 345 | CX-200 | 692 | 4.0 | 0.005 | 3 |
| example 6 | | | | | | | |
| Comparative | DBS | 345 | CX-200 | 692 | 4.0 | 0.1 | 40 |
| example 7 | | | | | | | |

### Example 11

The mite repellent A produced by the method of Example 1 was used, and the formability, repellency in early stage, durability of repellency, and water resistance were evaluated. The results were shown in Table 3.

### Examples 12 to 19

The mite repellents B to I produced by the methods of Examples 2 to 9 were used and evaluated in the same manner as in Example 11. The results were shown in Table 3.

### Comparative Examples 11 to 17

The mite repellents J to P produced by the methods of Comparative examples 1 to 7 were used and evaluated in the same manner as in Example 11. The results were shown in Table 3.

### Comparative Example 18

A mite repellent was molded by adding 0.4% dibutyl sebacate to a polypropylene resin without using an inorganic porous substance and evaluated in the same manner as in Example 11. The results were shown in Table 3.

### Comparative Example 19

A mite repellent was molded by adding 0.2% dibutyl sebacate to a polypropylene resin without using an inorganic porous substance and evaluated in the same manner as in Example 11. The results were shown in Table 3.

TABLE 3

| | Mite repellent | | Amount | | | | | |
|---|---|---|---|---|---|---|---|---|
| | | Added | of | | | Initial | Durability | Repellent |
| | | amount | chemical | | | repellent | of | water |
| | | (% by | (% by | Formability | | rate | repellency | resistance |
| | Type | mass) | mass) | Foam | Odor | (%) | (%) | (%) |
| Example 11 | A | 4.0 | 0.4 | 3 | 3 | 88 | 83 | 77 |
| Example 12 | B | 2.0 | 0.4 | 3 | 3 | 97 | 90 | 83 |
| Example 13 | C | 1.5 | 0.4 | 3 | 3 | 96 | 90 | 83 |
| Example 14 | D | 2.0 | 0.4 | 3 | 3 | 94 | 82 | 75 |
| Example 15 | E | 2.0 | 0.4 | 3 | 3 | 95 | 88 | 81 |
| Example 16 | F | 2.0 | 0.4 | 3 | 3 | 96 | 86 | 80 |
| Example 17 | G | 8.0 | 0.4 | 3 | 3 | 84 | 79 | 73 |
| Example 18 | H | 1.0 | 0.4 | 3 | 2 | 94 | 80 | 68 |
| Example 19 | I | 2.0 | 0.4 | 3 | 2 | 85 | 76 | 70 |
| Comparative | J | 2.0 | 0.4 | 1 | 1 | 76 | 56 | 46 |
| Example 11 | | | | | | | | |
| Comparative | K | 4.0 | 0.4 | 2 | 1 | 67 | 41 | 35 |
| Example 12 | | | | | | | | |
| Comparative | L | 2.5 | 0.4 | 1 | 1 | 73 | 44 | 31 |
| Example 13 | | | | | | | | |
| Comparative | M | 2.0 | 0.4 | 1 | 1 | 61 | 37 | 28 |
| Example 14 | | | | | | | | |
| Comparative | N | 2.0 | 0.4 | 1 | 1 | 72 | 49 | 41 |
| Example 15 | | | | | | | | |
| Comparative | O | 13.0 | 0.4 | 3 | 3 | 53 | 48 | 44 |
| Example 16 | | | | | | | | |
| Comparative | P | 1.0 | 0.4 | 1 | 1 | 60 | 35 | 26 |
| Example 17 | | | | | | | | |
| Comparative | DBS | 0.4 | 0.4 | 1 | 1 | 57 | 22 | <5 |
| Example 18 | | | | | | | | |
| Comparative | DBS | 0.2 | 0.2 | 2 | 2 | 16 | <5 | <5 |
| Example 19 | | | | | | | | |

In Table 3, the example indicated by “<5” in the column of durability of repellency shows that the measurement result of the durability of repellency is less than 5%, and the example indicated by “<5” in the column of repellent water resistance shows that the measurement result of the water resistance is less than 5%.

According to the results in Table 3, the formability of each of the mite repellents (mite repellents A to I) in Examples 1 to 9 is 2 or 3. It can be said that they have excellent formability.

The molded products produced by using the mite repellents (mite repellents A to I) in Examples 1 to 9 have an initial repellent rate of 80% or more, and thus they exhibit favorable mite repellency. It can be said that when the mite repellency of the molded product is excellent, naturally, the mite repellent effect of the mite repellent is excellent. The molded products produced by using the mite repellents (mite repellents A to H) in Examples 1 to 8 have a repellent rate of 79% or more in the evaluation of the durability of repellent performance, and thus they exhibit very favorable mite repellency. Further, the molded products produced by using the mite repellents (mite repellents A to I) in Examples 1 to 9 have a repellent rate of 70% or more in the evaluation of water resistance, and thus they exhibit very favorable mite repellency.

The reason why the formability and mite repellency of the molded products are excellent in the examples is that thermal decomposition or vaporization of the mite repellent is hardly caused by the heat treatment during molding. The mite repellent of the present invention is considered to have excellent heat resistance.

Meanwhile, the inorganic porous substances of Comparative examples 1 to 4 are beyond the scope of the present invention and the chemical of Comparative example 5 is a repellent beyond the scope of the present invention, and thus the formability and mite repellency are low. Comparative examples 6 and 7 show that when the supported amount of the chemical is beyond the scope of the present invention, sufficient mite repellency is not obtained.

### INDUSTRIAL APPLICABILITY

The mite repellent of the present invention has a high mite repellent effect and an appropriate sustained release property. In the case of processing by melting and kneading the mite repellent of the present invention and various resins, the chemical is not thermally decomposed or vaporized and the mite repellent has excellent heat resistance. Thus, the mite repellent of the present invention can impart excellent mite repellency to a product such as a fiber, a coating material, a sheet, or a molded product.

1. A mite repellent comprising a chemical supported on an inorganic porous substance, wherein:
the chemical is aliphatic dibasic acid dialkyl ester represented by the following Formula (1),
the inorganic porous substance has a BET specific surface area of from 550 to 1000 m²/g and a pore size of from 0.8 to 15 nm, and
a supported amount of the chemical is from 0.007 to 0.09 ml with respect to 100 m² of the BET specific surface area of the inorganic porous substance
ROOC(CH₂)ₙCOOR (1)
wherein, in formula (1), n represents an integer from 3 to 15, R represents an alkyl group having from 3 to 15 carbon atoms when n represents an integer from 3 to 8, and R represents an alkyl group having from 1 to 15 carbon atoms when n represents an integer from 9 to 15.

2. The mite repellent according to claim 1, wherein the chemical has a boiling point of 300° C. or higher.

3. The mite repellent according to claim 1, wherein the inorganic porous substance is at least one selected from the group consisting of a silicate compound, silica gel, zeolite, metal oxide, metal hydroxide, or a phosphate compound.

4. The mite repellent according to claim 1, wherein a water content in the inorganic porous substance before supporting the chemical is 3% by mass or less.

5. A mite-repellent resin composition comprising:
the mite repellent according to claim 1; and
a resin.

6. A mite repellent product comprising the mite repellent according to claim 1.
